(19) United States
(12) Patent Application Publication
(10) Pub. No.: US 2026/0056702 A1
(43) Pub. Date: Feb. 26, 2026

(54) DISPLAY DEVICE AND OPERATING METHOD THEREOF

(71) Applicant: LG ELECTRONICS INC., Seoul (KR)

(72) Inventors: Jaekyung LEE, Seoul (KR); Yongtae KIM, Seoul (KR)

(73) Assignee: LG ELECTRONICS INC., Seoul (KR)

(21) Appl. No.: 18/997,471

(22) PCT Filed: Jul. 19, 2022
(86) PCT No.: PCT/KR2022/010556

§ 371 Date: Jan. 21, 2025

(51) Int. Cl. G06F 3/16; G06F 16/73; H04N 21/422; H04N 21/488

(52) U.S. Cl. CPC G06F 3/167; G06F 16/73; H04N 21/42203; H04N 21/4882

(57) ABSTRACT

A display device according to an embodiment of the present disclosure comprises: a controller for receiving a speech command and obtaining an official content name mapped to an uttered content name included in the speech command; and a display for outputting an operation result corresponding to a speech command obtained by changing the uttered content name to the official content name. Thus, a display device in which a result intended by a user is provided even when a content name in a speech command is not accurate, and an operating method thereof, may be provided.

### TECHNICAL FIELD

The present disclosure relates to a display device and an operating method thereof.

### BACKGROUND ART

Digital TV services using wired or wireless communication networks are becoming common. The digital TV services may provide various services that cannot be provided by existing analog broadcasting services.

For example, in the case of IPTV (Internet Protocol Television) and smart TV services, which are types of digital TV services, interactivity is provided so that users can actively select the types of programs to watch, the viewing time, and the like. IPTV and smart TV services may provide various additional services, such as Internet search, home shopping, online games, etc., based on such interactivity.

In addition, display devices can receive commands to search for information about specific content or play content through voice commands, etc., and provide functions that respond to the received commands, thereby improving user convenience. However, recently, content names have been becoming more specific and longer, such as “Tail-to-Tail Story of That Day,” “You Quiz on the Block,” “Marriage Lyrics and Divorce Composition,” “Tomorrow is a National Singer,” “Current Affairs Show This is Politics,” and “I am a Natural Person.” In addition, as the number of contents increases, there are cases where completely different content but similar names are used, such as “Shin Tong Bang Tong (Current Affairs/Educational Program)” and “Shin Tong Bang Tong Curiosity Exploration Team (Children's Program).”

As a result, users are experiencing difficulties in giving the desired command by voice because they do not know the exact content name. In addition, if the user gives a voice command using a keyword or abbreviation even though he or she knows the exact content name, there is a problem in that the user can not receive the desired function.

### DISCLOSURE

### Technical Problem

The purpose of the present disclosure is to provide a display device and an operating method thereof that provide a result intended by a user even if the content name of the voice command is not accurate.

The purpose of the present disclosure is to provide a display device and an operating method thereof that provide a result according to a user voice command more accurately in response to the tendency for content names to be diverse and long.

### Technical Solution

A display device according to an embodiment of the present disclosure may include a controller configured to receive a voice command and obtain an official content name mapped to an uttered content name included in the voice command, and a display configured to output an operation result corresponding to a voice command in which the uttered content name is changed to the official content name.

When the controller receives a voice command, the controller may obtain whether the uttered content name is stored in a content name database.

When the uttered content name is stored in the content name database, the controller may obtain an official content name mapped to the uttered content name.

When the uttered content name is not stored in the content name database, the controller may output an operation result corresponding to the voice command according to the uttered content name.

When the controller outputs a search result of the uttered content name as an operation result, if any one content is selected from the search result, the controller may output a message confirming whether the uttered content name is set as a user-customized content name.

When the controller receives a command to set the uttered content name to the user-customized content name, the controller can map the official content name of the selected content and the uttered content name and store them in the content name database.

When the controller outputs the search result of the uttered content name as the operation result, if any content is selected from the search result, the controller can map the official content name of the selected content and the uttered content name and store them in the content name database.

If the selected content corresponds to a series, the controller can map the official content name including a season number of the selected content to the uttered content name and store them in the content name database.

If the content corresponding to the official content name is a series, the controller can output the operation result and the content of a different season together.

If the content of the different season is selected, the controller can change the season number of the official content name mapped to the uttered content name to the number of the selected different season.

The display device may further include a memory configured to store a content name database in which one or more uttered content names are mapped and stored to one official content name.

The controller may obtain the official content name and the operation result of the voice command changed to the official content name through an external server that manages the content name database.

The controller may obtain the official content name corresponding to the uttered content name from a content name database that is customized for the user or an utterance log database that is set based on the frequency of multiple users.

If the controller fails to obtain the official content name from the content name database, it may obtain the official content name from the utterance log database.

The operating method of the display device according to the embodiment of the present disclosure may include a step of receiving a voice command, a step of obtaining an official content name mapped to an uttered content name included in the voice command, and a step of outputting an operation result corresponding to the voice command in which the uttered content name is changed to the official content name.

### Advantageous Effects

According to the present disclosure, even if an inaccurate content name is received as a voice command, the user's intended result can be provided, and thus, user convenience and reliability are improved.

According to the present disclosure, even if a voice command is received as a core word (keyword) or an abbreviation, a result for the corresponding content can be provided, and thus, there is an advantage in that the result for the voice command is provided more accurately.

According to the present disclosure, even if the same content is called by different names for each user, there is an advantage in that a result for the content corresponding to the user's intention can be provided.

### DESCRIPTION OF DRAWINGS

FIG. 1 is a block diagram illustrating a configuration of a display device according to an embodiment of the present invention.

FIG. 2 is a block diagram of a remote control device according to an embodiment of the present invention.

FIG. 3 shows an example of an actual configuration of a remote control device according to an embodiment of the present invention.

FIG. 4 shows an example of utilizing a remote control device according to an embodiment of the present invention.

FIG. 5 is a flowchart illustrating an operation method of a display device according to an embodiment of the present disclosure.

FIG. 6 is an example diagram illustrating a display device according to an embodiment of the present disclosure performing an operation corresponding to a voice command according to an uttered content name.

FIG. 7 is an example diagram illustrating a display device according to an embodiment of the present disclosure receiving a command to select one content from a voice command result.

FIG. 8 is an exemplary drawing showing a display device according to an embodiment of the present disclosure outputting a message for confirming whether to store an uttered content name in a content name DB.

FIG. 9 is an example diagram illustrating a display device according to an embodiment of the present disclosure performing an operation corresponding to a voice command by replacing the uttered content name with an official content name.

FIG. 10 is an example diagram illustrating a display device according to an embodiment of the present disclosure performing an operation corresponding to a voice command according to the uttered content name.

FIG. 11 is an exemplary drawing illustrating a display device according to an embodiment of the present disclosure receiving a command to select one content from a voice command result.

FIG. 12 is an exemplary drawing showing a display device according to an embodiment of the present disclosure outputting a message for confirming whether to store an uttered content name in a content name DB.

FIG. 13 is an exemplary drawing illustrating a display device according to an embodiment of the present disclosure performing an operation corresponding to a voice command by replacing an uttered content name with an official content name.

FIG. 14 is an exemplary drawing illustrating a display device according to an embodiment of the present disclosure displaying another season when the content corresponds to a series and the voice command is a content playback command.

FIG. 15 is an exemplary drawing illustrating a display device according to an embodiment of the present disclosure receiving a command to select content of another season.

FIG. 16 is an exemplary drawing showing a message output appearance for confirming whether to change an official content name mapped to an uttered content name by a display device according to an embodiment of the present disclosure.

FIG. 17 is an exemplary drawing showing an operation appearance of a display device according to an embodiment of the present disclosure according to a change in an official content name.

FIG. 18 is a block diagram showing an appearance of a display device according to an embodiment of the present disclosure communicating with an external server.

FIG. 19 is a flowchart showing an operation method of a display device according to another embodiment of the present disclosure.

### BEST MODE

Hereinafter, embodiments of the present disclosure will be described in detail with reference to the drawings. The suffixes “module” and “unit or portion” for components used in the following description are merely provided only for facilitation of preparing this specification, and thus they are not granted a specific meaning or function.

A display device according to an embodiment of the present disclosure is, for example, an intelligent display device in which a computer support function is added to a broadcast reception function, and may have an easy-to-use interface such as a handwritten input device, a touch screen, a spatial remote control, or the like since an Internet function is added while fulfilling the broadcast receiving function. In addition, it is connected to the Internet and a computer with the support of a wired or wireless Internet function, so that functions such as e-mail, web browsing, banking, or games can also be performed. A standardized general-purpose OS may be used for these various functions.

Accordingly, in the display device described in the present disclosure, various user-friendly functions can be performed because various applications can be freely added or deleted, for example, on a general-purpose OS kernel. More specifically, the display device may be, for example, a network TV, HBBTV, smart TV, LED TV, OLED TV, and the like, and may be applied to a smart phone in some cases.

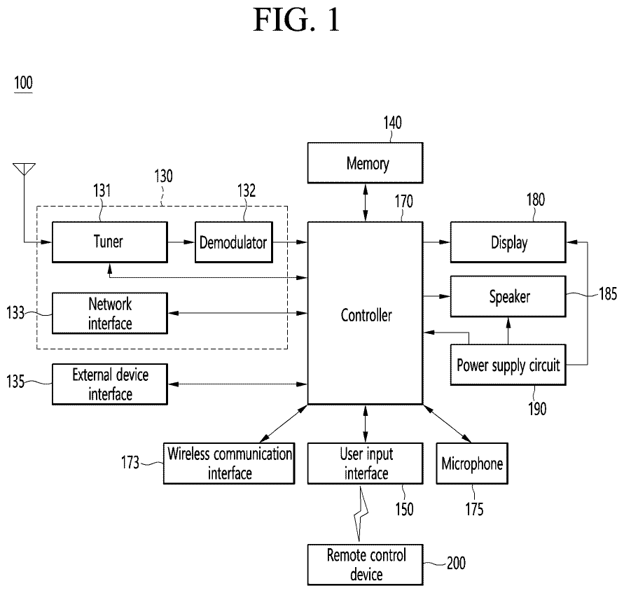

FIG. 1 is a block diagram showing a configuration of a display device according to an embodiment of the present disclosure.

Referring to FIG. 1, a display device 100 may include a broadcast receiver 130, an external device interface 135, a memory 140, a user input interface 150, a controller 170, a wireless communication interface 173, a display 180, a speaker 185, and a power supply circuit 190.

The broadcast receiver 130 may include a tuner 131, a demodulator 132, and a network interface 133.

The tuner 131 may select a specific broadcast channel according to a channel selection command. The tuner 131 may receive a broadcast signal for the selected specific broadcast channel.

The demodulator 132 may separate the received broadcast signal into an image signal, an audio signal, and a data signal related to a broadcast program, and restore the separated image signal, audio signal, and data signal to a format capable of being output.

The external device interface 135 may receive an application or a list of applications in an external device adjacent thereto, and transmit the same to the controller 170 or the memory 140.

The external device interface 135 may provide a connection path between the display device 100 and an external device. The external device interface 135 may receive one or more of images and audio output from an external device connected to the display device 100 in a wired or wireless manner, and transmit the same to the controller 170. The external device interface 135 may include a plurality of external input terminals. The plurality of external input terminals may include an RGB terminal, one or more High Definition Multimedia Interface (HDMI) terminals, and a component terminal.

The image signal of the external device input through the external device interface 135 may be output through the display 180. The audio signal of the external device input through the external device interface 135 may be output through the speaker 185.

The external device connectable to the external device interface 135 may be any one of a set-top box, a Blu-ray player, a DVD player, a game machine, a sound bar, a smartphone, a PC, a USB memory, and a home theater, but this is only an example.

The network interface 133 may provide an interface for connecting the display device 100 to a wired/wireless network including an Internet network. The network interface 133 may transmit or receive data to or from other users or other electronic devices through a connected network or another network linked to the connected network.

In addition, a part of content data stored in the display device 100 may be transmitted to a selected user among a selected user or a selected electronic device among other users or other electronic devices registered in advance in the display device 100.

The network interface 133 may access a predetermined web page through the connected network or the other network linked to the connected network. That is, it is possible to access a predetermined web page through a network, and transmit or receive data to or from a corresponding server.

In addition, the network interface 133 may receive content or data provided by a contents provider or a network operator. That is, the network interface 133 may receive content such as movies, advertisements, games, VOD, and broadcast signals and information related thereto provided from a contents provider or a network provider through a network.

In addition, the network interface 133 may receive update information and update files of firmware provided by the network operator, and may transmit data to an Internet or contents provider or a network operator.

The network interface 133 may select and receive a desired application from among applications that are open to the public through a network.

The memory 140 may store programs for signal processing and control of the controller 170, and may store images, audio, or data signals, which have been subjected to signal-processed.

In addition, the memory 140 may perform a function for temporarily storing images, audio, or data signals input from an external device interface 135 or the network interface 133, and store information on a predetermined image through a channel storage function.

The memory 140 may store an application or a list of applications input from the external device interface 135 or the network interface 133.

The display device 100 may play a content file (a moving image file, a still image file, a music file, a document file, an application file, or the like) stored in the memory 140 and provide the same to the user.

The user input interface 150 may transmit a signal input by the user to the controller 170 or a signal from the controller 170 to the user. For example, the user input interface 150 may receive and process a control signal such as power on/off, channel selection, screen settings, and the like from the remote control device 200 in accordance with various communication methods, such as a Bluetooth communication method, a WB (Ultra Wideband) communication method, a ZigBee communication method, an RF (Radio Frequency) communication method, or an infrared (IR) communication method or may perform processing to transmit the control signal from the controller 170 to the remote control device 200.

In addition, the user input interface 150 may transmit a control signal input from a local key (not shown) such as a power key, a channel key, a volume key, and a setting value to the controller 170.

The image signal image-processed by the controller 170 may be input to the display 180 and displayed as an image corresponding to a corresponding image signal. Also, the image signal image-processed by the controller 170 may be input to an external output device through the external device interface 135.

The audio signal processed by the controller 170 may be output to the speaker 185. Also, the audio signal processed by the controller 170 may be input to the external output device through the external device interface 135.

In addition, the controller 170 may control the overall operation of the display device 100.

In addition, the controller 170 may control the display device 100 by a user command input through the user input interface 150 or an internal program and connect to a network to download an application a list of applications or applications desired by the user to the display device 100.

The controller 170 may allow the channel information or the like selected by the user to be output through the display 180 or the speaker 185 along with the processed image or audio signal.

In addition, the controller 170 may output an image signal or an audio signal through the display 180 or the speaker 185, according to a command for playing an image of an external device through the user input interface 150, the image signal or the audio signal being input from an external device, for example, a camera or a camcorder, through the external device interface 135.

Meanwhile, the controller 170 may allow the display 180 to display an image, for example, allow a broadcast image which is input through the tuner 131 or an external input image which is input through the external device interface 135, an image which is input through the network interface or an image which is stored in the memory 140 to be displayed on the display 180. In this case, an image being displayed on the display 180 may be a still image or a moving image, and may be a 2D image or a 3D image.

In addition, the controller 170 may allow content stored in the display device 100, received broadcast content, or external input content input from the outside to be played, and the content may have various forms such as a broadcast image, an external input image, an audio file, still images, accessed web screens, and document files.

The wireless communication interface 173 may communicate with an external device through wired or wireless communication. The wireless communication interface 173 may perform short range communication with an external device. To this end, the wireless communication interface 173 may support short range communication using at least one of Bluetooth™, Radio Frequency Identification (RFID), Infrared Data Association (IrDA), Ultra Wideband (UWB), ZigBee, Near Field Communication (NFC), Wi-Fi (Wireless-Fidelity), Wi-Fi (Wireless-Fidelity), Wi-Fi Direct, and Wireless USB (Wireless Universal Serial Bus) technologies. The wireless communication interface 173 may support wireless communication between the display device 100 and a wireless communication system, between the display device 100 and another display device 100, or between the display device 100 and a network in which the display device 100 (or an external server) is located through wireless area networks. The wireless area networks may be wireless personal area networks.

Here, another display device 100 may be a wearable device (e.g., a smartwatch, smart glasses or a head mounted display (HMD), a mobile terminal such as a smart phone, which is able to exchange data (or interwork) with the display device 100 according to the present disclosure. The wireless communication interface 173 may detect (or recognize) a wearable device capable of communication around the display device 100.

Furthermore, when the detected wearable device is an authenticated device to communicate with the display device 100 according to the present disclosure, the controller 170 may transmit at least a portion of data processed by the display device 100 to the wearable device through the wireless communication interface 173. Therefore, a user of the wearable device may use data processed by the display device 100 through the wearable device.

The microphone 175 can acquire audio. The microphone 175 can acquire audio around the display device 100.

The display 180 may convert image signals, data signals, and OSD signals processed by the controller 170, or image signals or data signals received from the external device interface 135 into R, G, and B signals, and generate drive signals.

Meanwhile, since the display device 100 shown in FIG. 1 is only an embodiment of the present disclosure, some of the illustrated components may be integrated, added, or omitted depending on the specification of the display device 100 that is actually implemented.

That is, two or more components may be combined into one component, or one component may be divided into two or more components as necessary. In addition, a function performed in each block is for describing an embodiment of the present disclosure, and its specific operation or device does not limit the scope of the present disclosure.

According to another embodiment of the present disclosure, unlike the display device 100 shown in FIG. 1, the display device 100 may receive an image through the network interface 133 or the external device interface 135 without a tuner 131 and a demodulator 132 and play the same.

For example, the display device 100 may be divided into an image processing device, such as a set-top box, for receiving broadcast signals or content according to various network services, and a content playback device that plays content input from the image processing device.

In this case, an operation method of the display device according to an embodiment of the present disclosure will be described below may be implemented by not only the display device 100 as described with reference to FIG. 1 and but also one of an image processing device such as the separated set-top box and a content playback device including the display 180 and the speaker 185.

The speaker 185 receives the voice-processed signal from the controller 170 and outputs it as voice.

The power supply circuit 190 supplies the corresponding power throughout the display device 100. In particular, power can be supplied to the controller 170, which can be implemented in the form of a system on chip (SOC), the display 180 for displaying images, and the speaker 185 for audio output.

Specifically, the power supply circuit 190 may include a converter that converts AC power to DC power and a dc/dc converter that converts the level of DC power.

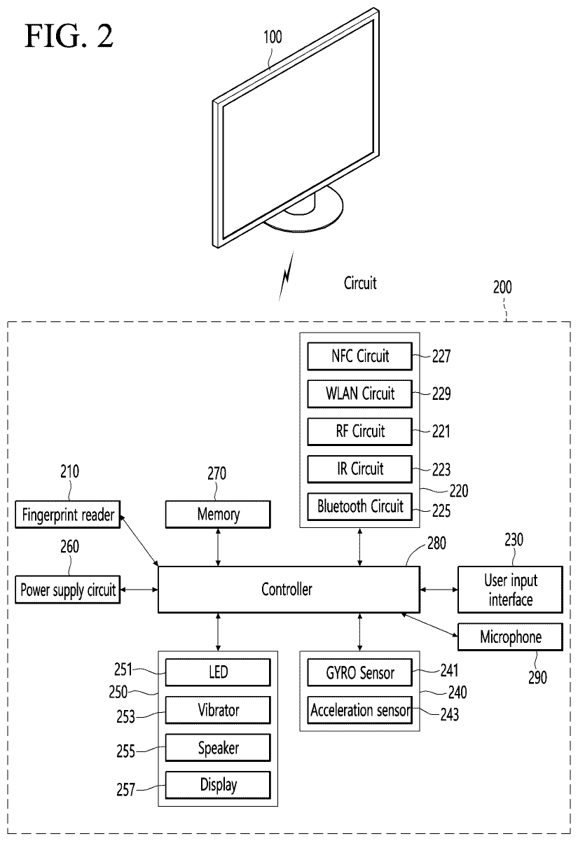

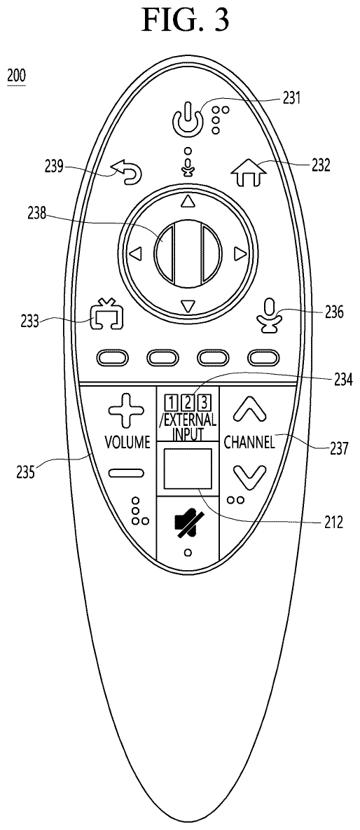

Next, a remote control device according to an embodiment of the present disclosure will be described with reference to FIGS. 2 to 3.

FIG. 2 is a block diagram of a remote control device according to an embodiment of the present disclosure, and FIG. 3 shows an actual configuration example of a remote control device 200 according to an embodiment of the present disclosure.

First, referring to FIG. 2, the remote control device 200 may include a fingerprint reader 210, a wireless communication circuit 220, a user input interface 230, a sensor 240, an output interface 250, a power supply circuit 260, a memory 270, a controller 280, and a microphone 290.

Referring to FIG. 2, the wireless communication circuit 220 may transmit and receive signals to and from any one of display devices according to embodiments of the present disclosure described above.

The remote control device 200 may include an RF circuit 221 capable of transmitting and receiving signals to and from the display device 100 according to the RF communication standard, and an IR circuit 223 capable of transmitting and receiving signals to and from the display device 100 according to the IR communication standard. In addition, the remote control device 200 may include a Bluetooth circuit 225 capable of transmitting and receiving signals to and from the display device 100 according to the Bluetooth communication standard. In addition, the remote control device 200 may include an NFC circuit 227 capable of transmitting and receiving signals to and from the display device 100 according to the NFC (near field communication) communication standard, and a WLAN circuit 229 capable of transmitting and receiving signals to and from the display device 100 according to the wireless LAN (WLAN) communication standard.

In addition, the remote control device 200 may transmit a signal containing information on the movement of the remote control device 200 to the display device 100 through the wireless communication circuit 220.

In addition, the remote control device 200 may receive a signal transmitted by the display device 100 through the RF circuit 221, and transmit a command regarding power on/off, channel change, volume adjustment, or the like to the display device 100 through the IR circuit 223 as necessary.

The user input interface 230 may include a keypad, a button, a touch pad, a touch screen, or the like. The user may input a command related to the display device 100 to the remote control device 200 by operating the user input interface 230. When the user input interface 230 includes a hard key button, the user may input a command related to the display device 100 to the remote control device 200 through a push operation of the hard key button. Details will be described with reference to FIG. 3.

Referring to FIG. 3, the remote control device 200 may include a plurality of buttons. The plurality of buttons may include a fingerprint recognition button 212, a power button 231, a home button 232, a live button 233, an external input button 234, a volume control button 235, a voice recognition button 236, a channel change button 237, an OK button 238, and a back-play button 239.

The fingerprint recognition button 212 may be a button for recognizing a user's fingerprint. In one embodiment, the fingerprint recognition button 212 may enable a push operation, and thus may receive a push operation and a fingerprint recognition operation.

The power button 231 may be a button for turning on/off the power of the display device 100.

The home button 232 may be a button for moving to the home screen of the display device 100.

The live button 233 may be a button for displaying a real-time broadcast program.

The external input button 234 may be a button for receiving an external input connected to the display device 100.

The volume control button 235 may be a button for adjusting the level of the volume output by the display device 100.

The voice recognition button 236 may be a button for receiving a user's voice and recognizing the received voice.

The channel change button 237 may be a button for receiving a broadcast signal of a specific broadcast channel.

The OK button 238 may be a button for selecting a specific function, and the back-play button 239 may be a button for returning to a previous screen.

A description will be given referring again to FIG. 2.

When the user input interface 230 includes a touch screen, the user may input a command related to the display device 100 to the remote control device 200 by touching a soft key of the touch screen. In addition, the user input interface 230 may include various types of input means that may be operated by a user, such as a scroll key or a jog key, and the present embodiment does not limit the scope of the present disclosure.

The sensor 240 may include a gyro sensor 241 or an acceleration sensor 243, and the gyro sensor 241 may sense information regarding the movement of the remote control device 200.

For example, the gyro sensor 241 may sense information about the operation of the remote control device 200 based on the x, y, and z axes, and the acceleration sensor 243 may sense information about the moving speed of the remote control device 200. Meanwhile, the remote control device 200 may further include a distance measuring sensor to sense the distance between the display device 100 and the display 180.

The output interface 250 may output an image or audio signal corresponding to the operation of the user input interface 230 or a signal transmitted from the display device 100.

The user may recognize whether the user input interface 230 is operated or whether the display device 100 is controlled through the output interface 250.

For example, the output interface 450 may include an LED 251 that emits light, a vibrator 253 that generates vibration, a speaker 255 that outputs sound, or a display 257 that outputs an image when the user input interface 230 is operated or a signal is transmitted and received to and from the display device 100 through the wireless communication interface 225.

In addition, the power supply circuit 260 may supply power to the remote control device 200, and stop power supply when the remote control device 200 has not moved for a predetermined time to reduce power consumption.

The power supply circuit 260 may restart power supply when a predetermined key provided in the remote control device 200 is operated.

The memory 270 may store various types of programs and application data required for control or operation of the remote control device 200.

When the remote control device 200 transmits and receives signals wirelessly through the display device 100 and the RF circuit 221, the remote control device 200 and the display device 100 transmit and receive signals through a predetermined frequency band.

The controller 280 of the remote control device 200 may store and refer to information on a frequency band capable of wirelessly transmitting and receiving signals to and from the display device 100 paired with the remote control device 200 in the memory 270.

The controller 280 may control all matters related to the control of the remote control device 200. The controller 280 may transmit a signal corresponding to a predetermined key operation of the user input interface 235 or a signal corresponding to the movement of the remote control device 200 sensed by the sensor 240 through the wireless communication interface 225.

Also, the microphone 290 of the remote control device 200 may obtain a speech.

A plurality of microphones 290 may be provided.

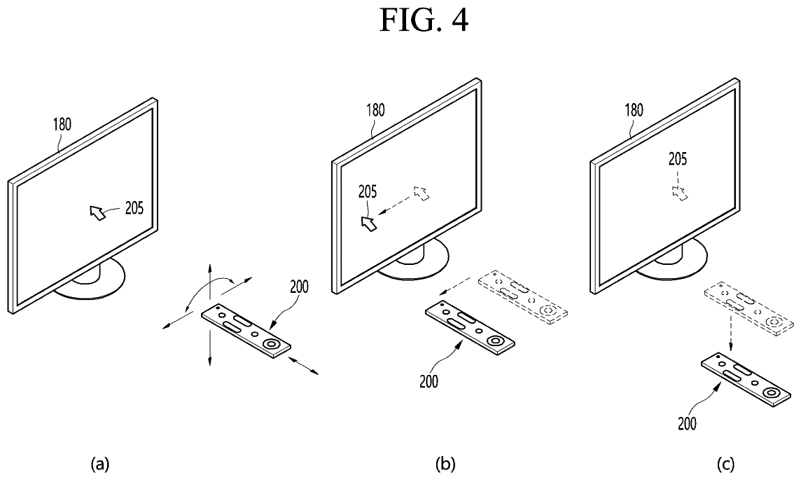

Next, a description will be given referring to FIG. 4.

FIG. 4 shows an example of using a remote control device according to an embodiment of the present disclosure.

In FIG. 4, (a) illustrates that a pointer 205 corresponding to the remote control device 200 is displayed on the display 180.

The user may move or rotate the remote control device 200 up, down, left and right. The pointer 205 displayed on the display 180 of the display device 100 may correspond to the movement of the remote control device 200. As shown in the drawings, the pointer 205 is moved and displayed according to movement of the remote control device 200 in a 3D space, so the remote control device 200 may be called a space remote control device.

In (b) of FIG. 4, it is illustrated that that when the user moves the remote control device 200 to the left, the pointer 205 displayed on the display 180 of the display device 100 moves to the left correspondingly.

Information on the movement of the remote control device 200 detected through a sensor of the remote control device 200 is transmitted to the display device 100. The display device 100 may calculate the coordinates of the pointer 205 based on information on the movement of the remote control device 200. The display device 100 may display the pointer 205 to correspond to the calculated coordinates.

In (c) of FIG. 4, it is illustrated that a user moves the remote control device 200 away from the display 180 while pressing a specific button in the remote control device 200. Accordingly, a selected area in the display 180 corresponding to the pointer 205 may be zoomed in and displayed enlarged.

Conversely, when the user moves the remote control device 200 to be close to the display 180, the selected area in the display 180 corresponding to the pointer 205 may be zoomed out and displayed reduced.

On the other hand, when the remote control device 200 moves away from the display 180, the selected area may be zoomed out, and when the remote control device 200 moves to be close to the display 180, the selected area may be zoomed in.

Also, in a state in which a specific button in the remote control device 200 is being pressed, recognition of up, down, left, or right movements may be excluded. That is, when the remote control device 200 moves away from or close to the display 180, the up, down, left, or right movements are not recognized, and only the forward and backward movements may be recognized. In a state in which a specific button in the remote control device 200 is not being pressed, only the pointer 205 moves according to the up, down, left, or right movements of the remote control device 200.

Meanwhile, the movement speed or the movement direction of the pointer 205 may correspond to the movement speed or the movement direction of the remote control device 200.

Meanwhile, in the present specification, a pointer refers to an object displayed on the display 180 in response to an operation of the remote control device 200. Accordingly, objects of various shapes other than the arrow shape shown in the drawings are possible as the pointer 205. For example, the object may be a concept including a dot, a cursor, a prompt, a thick outline, and the like. In addition, the pointer 205 may be displayed corresponding to any one point among points on a horizontal axis and a vertical axis on the display 180, and may also be displayed corresponding to a plurality of points such as a line and a surface.

The display device 100 can receive various types of commands, such as searching for information about specific content or playing specific content, through voice commands, and can provide functions such as outputting information or playing content according to the received commands.

However, recently, content names have tended to become more specific and longer. In addition, as the number of contents increases, there are cases where similar names are used for completely different content. Accordingly, users are experiencing difficulties in giving desired commands through voice commands because they do not know the exact content names. In addition, even if the user knows the exact content name, there is a problem in that the user's desired function cannot be provided if the voice command is given using a keyword or abbreviation. In particular, in the case of a command to search for specific content, it is possible to provide the user's desired result by providing multiple contents through partial search, but in the case of searching for detailed information of specific content (e.g., characters, broadcast time, etc.) or executing commands such as scheduled recording or playing, there is a problem that it is difficult to immediately execute the function the user wants.

The present disclosure provides a display device 100 that can normally provide a function according to a voice command for a content when a voice command is received with the same name again later when a content name received with a voice command is not the official name of the content.

The display device 100 according to an embodiment of the present disclosure receives a voice command for searching for content with a different name that does not exactly match, displays the search result with the received name, and when one of the displayed results is selected, provides the result of the voice command for the selected content when a voice command with the same name is received later.

Through this, the display device 100 provides a function desired by a user even when a name that does not match the official name, such as a key word(s) or an abbreviation, is spoken.

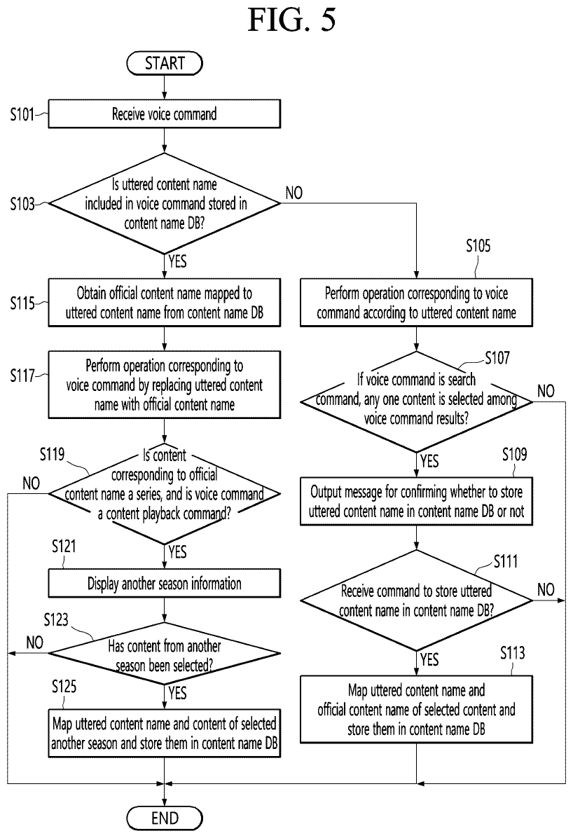

FIG. 5 is a flowchart illustrating an operation method of a display device according to an embodiment of the present disclosure.

The controller 170 can receive a voice command (S101).

The controller 170 can receive a voice command through the microphone 175. Alternatively, the controller 170 can receive a voice command recognized through the microphone 290 and transmitted from the remote control device 200 through the user input interface 150.

The voice command can be various, such as a command to search for the content itself, a command to search for detailed information of the content (e.g., characters, broadcast time, etc.), a command to play the content, a command for recording/scheduled recording of the content, etc.

When the controller 170 receives a voice command, it can obtain whether there is a content corresponding to the content name included in the voice command. If there is a content corresponding to the content name included in the voice command, the controller 170 can provide the result of the voice command corresponding to the content. However, if the content name is a keyword(s) or an abbreviation, it may be determined that the content does not exist. If the content corresponding to the content name included in the voice command does not exist, the controller 170 may operate as described below.

The controller 170 may determine whether an uttered content name included in the voice command is stored in the content name DB (S103).

The content name DB (content name database) may be a database that stores and manages user-customized content names. The content name DB may have official content names and uttered content names mapped to each content.

The official content name may mean the official name determined by the production company (or distributor, etc.) of the content. In other words, the official content name may be the actual content name corresponding to the uttered content name.

The uttered content name may mean the content name that the user calls for convenience. The uttered content name may be some key word(s) extracted from the official content name or an abbreviation of the official content name. The uttered content name may be a content name extracted from a voice command.

The content name DB may be pre-built. The data stored in the content name DB may be modified. For example, the controller 170 may update the content name DB by changing the season number in step S215 described below.

The content name DB may store one or more uttered content names mapped to one official content name. That is, the uttered content name mapped to the official content name may be one or more.

Meanwhile, if the content is a series, the official content name mapped to the uttered content name may be the name of the content of a specific season. However, depending on the embodiment, if the content is a series, the official content name mapped to the uttered content name may be a content name that includes all seasons. That is, if the content is a series, the official content name mapped to the uttered content name may include only one season number or may include numbers of all seasons. In the present disclosure, it is assumed that only content of a specific season is mapped to the uttered content name, but this is only an example, and thus it is reasonable that the present disclosure is not limited thereto.

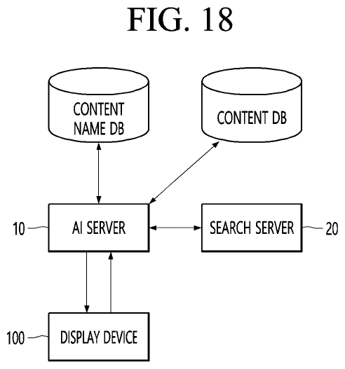

Such a content name DB may be stored in the memory 140, or may be managed separately in an external server 10 as described later in FIG. 18.

Below, Table 1 is an example of a content name DB.

TABLE 1

| Official content name | Uttered content name |
|---|---|
| The story of that day that | The story that bites one's tail after |
| bites one's tail | another, Bites one's tail |
| I am a natural person | Natural person |
| You Quiz on the Block | U-Kids, U-Quiz |
| Kim Jin's fastball show | Fastball show |
| Current affairs show, this | This is politics |
| is politics | |
| Marriage Lyrics Divorce | Marriage Composition Divorce Lyrics, |
| Composition 2 | Marriage lyrics, Divorce composition |
| I can see your voice 2 | Your voice, Voice |
| Vivid information forum | Information forum |
| Military prosecutor Doberman | Military prosecutor, Doberman |
| Curiosity Exploration Team | Exploring curiosity, Exploration Team |

However, since Table 1 is only an example for the convenience of explanation, it is reasonable that it is not limited thereto.

If the uttered content name included in the voice command is not stored in the content name DB, the controller 170 can perform an operation corresponding to the voice command according to the uttered content name (S105).

That is, if the uttered content name included in the voice command is not stored in the content name DB, the controller 170 can perform an operaion corresponding to the received voice command. For example, if the controller 170 receives a voice command such as “Find me a national singer,” it can perform an operation corresponding to “Find me a national singer.” If the controller 170 receives a voice command such as “Play me a national singer,” it can perform an operation corresponding to “Play me a national singer.” That is, even if the uttered content name included in the voice command is different from the official content name, the controller 170 can perform an operation corresponding to the voice command including the uttered content name as it is.

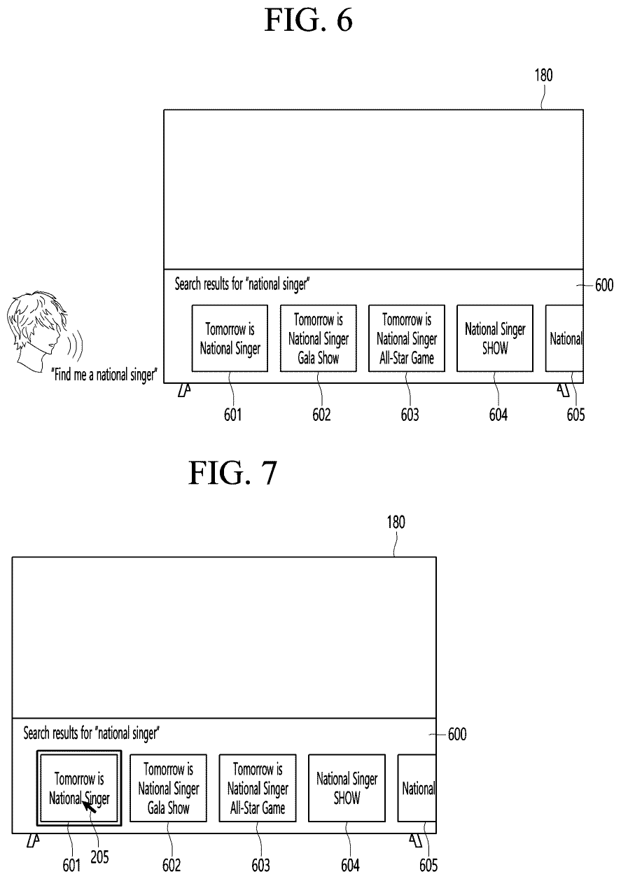

FIG. 6 is an exemplary drawing illustrating an example of a display device according to an embodiment of the present disclosure performing an operation corresponding to a voice command according to the uttered content name.

The controller 170 receives a voice command such as “Find me a national singer” but the uttered content name ‘national singer’ included in the voice command does not correspond to an official content name and may not be included in the content name DB. In this case, the controller 170 can display a screen that searches for ‘national singer’, which may be the same as the example of FIG. 6. That is, the controller 170 can display a content search result 600 searched for by the uttered content name included in the voice command, and the content search result 600 can include a plurality of contents 601 to 605. The plurality of contents 601 to 605 can be contents related to the uttered content name.

Again, FIG. 5 is described.

If the voice command is a search command, the controller 170 may determine whether any content is selected or not from the voice command results (S107).

That is, the controller 170 can terminate after performing an operation corresponding to the voice command if the voice command is a command other than the search command. However, the controller 170 can obtain whether any content is selected or not from the voice command result if the voice command is the search command. The controller 170 can obtain whether any content is selected or not from the voice command result, i.e., content search result 600.

The controller 170 can output a message for confirming whether to store the uttered content name in the content name DB if which content is selected from the voice command result (S109).

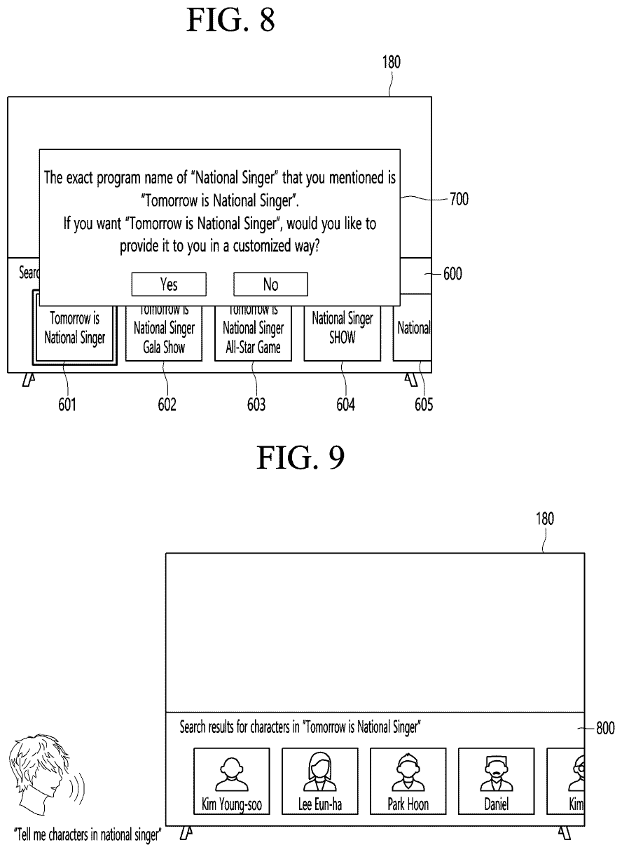

FIG. 7 is an exemplary drawing illustrating a display device according to an embodiment of the present disclosure receiving a command to select any one content from the voice command result. FIG. 8 is an example drawing showing a display device according to an embodiment of the present disclosure outputting a message for confirming whether to store a utterance content name in a content name DB.

The controller 170 can receive a command to select one from the content search result 600 through the pointer 205. When one content is selected, the controller 170 can display a message to check whether to manage the official content name of the selected content and the uttered content name by mapping them. That is, when one content is selected, the controller 170 can output a message to check whether to set the uttered content name as a user-customized content name.

As in the example of FIG. 7, the controller 170 can receive a command to select the first content 601 from the content search result 600, and in this case, can output a message to check whether to set the uttered content name as the user-customized content name. Referring to the example of FIG. 8, the message 700 may be something like, “The exact program name of “National Singer” that you mentioned is “Tomorrow is National Singer”. If you want “Tomorrow is National Singer”, would you like to provide it to you in a customized way?”, but this is only an example.

The controller 170 may receive user input on whether to set the uttered content name as the user-customized content name after outputting the message. The command to set the uttered content name as the user-customized content name may be the same as the command to store the uttered content name in the content name DB.

The controller 170 may output the message and determine whether or not a command to store the uttered content name in the content name DB has been received (S111).

When the controller 170 receives a command to set the uttered content name to the user-customized content name, it can recognize that it has received a command to store the uttered content name in the content name DB. The controller 170 can also directly receive a command to store the uttered content name in the content name DB.

When the controller 170 receives a command to store the uttered content name in the content name DB, it can map the uttered content name and the official content name of the selected content and store them in the content name DB (S113).

That is, when the controller 170 receives a command to set the uttered content name as the user-customized content name, it can map the official content name of the selected content and the uttered content name and store them in the content name DB.

For example, when the content name DB is in a state as in Table 1 described above, when it receives a command to map the uttered content name “National Singer” and the official content name “Tomorrow is National Singer” of the selected content and store them in the content name DB, the controller 170 can update the content name DB as in Table 2.

TABLE 2

| Official content name | Uttered content name |
|---|---|
| Tomorrow is National Singer | National Singer |
| The story of that day that | The story that bites one's tail after |
| bites one's tail | another, Bites one's tail |
| I am a natural person | Natural person |
| You Quiz on the Block | U-Kids, U-Quiz |
| Kim Jin's fastball show | Fastball show |
| Current affairs show, this | This is politics |
| is politics | |
| Marriage Lyrics Divorce | Marriage Composition Divorce Lyrics, |
| Composition 2 | Marriage lyrics, Divorce composition |
| I can see your voice 2 | Your voice, Voice |
| Vivid information forum | Information forum |
| Military prosecutor Doberman | Military prosecutor, Doberman |
| Curiosity Exploration Team | Exploring curiosity, Exploration Team |

Meanwhile, in step S103 of FIG. 5, the uttered content name included in the voice command may be stored in the content name DB. For example, when the content name DB is as described in Table 2 above, a voice command such as “Tell me characters in national singer” can be received.

When the uttered content name included in the voice command is stored in the content name DB, the controller 170 can obtain the official content name mapped to the uttered content name from the content name DB (S115).

For example, when the content name DB is as described in Table 2 above, when the controller 170 receives the voice command “Tell me characters in national singer”, the official content name “Tomorrow is National Singer” can be obtained.

The controller 170 can perform an operation corresponding to the voice command by replacing the uttered content name with the official content name (S119).

That is, the controller 170 can obtain the official content name mapped to the uttered content name included in the voice command, and output an operation result corresponding to the voice command in which the uttered content name is changed to the official content name.

FIG. 9 is an example drawing showing a display device according to an embodiment of the present disclosure performing an operation corresponding to a voice command by replacing an uttered content name with an official content name.

When the controller 170 receives the voice command “Tell me characters in national singer”, the controller 170 can obtain the official content name “Tomorrow is National Singer” mapped to the uttered content name “National singer”. The controller 170 can perform an operation corresponding to the voice command “Tell me characters in the Tomorrow is National Singer” where “National singer” is changed to “Tomorrow is national singer.”

As in the example of FIG. 9, the controller 170 can perform an operation corresponding to the voice command that replaces the content name, and display a character search result 800 as a result of the voice command.

According to an embodiment, the controller 170 can terminate the process after performing an operation corresponding to the voice command according to step S117.

Meanwhile, as illustrated in FIG. 5 according to an embodiment, the controller 170 can perform an operation corresponding to a voice command and determine whether the content corresponding to the official content name is a series and whether the voice command is a content playback command.

That is, the controller 170 can obtain whether the content corresponding to the official content name is a series and whether the voice command is a content playback command (S119).

If the content corresponds to a series and the voice command is a content playback command, the controller 170 can display another season information (S121).

Next, the operation appearance when the content corresponds to a series will be described.

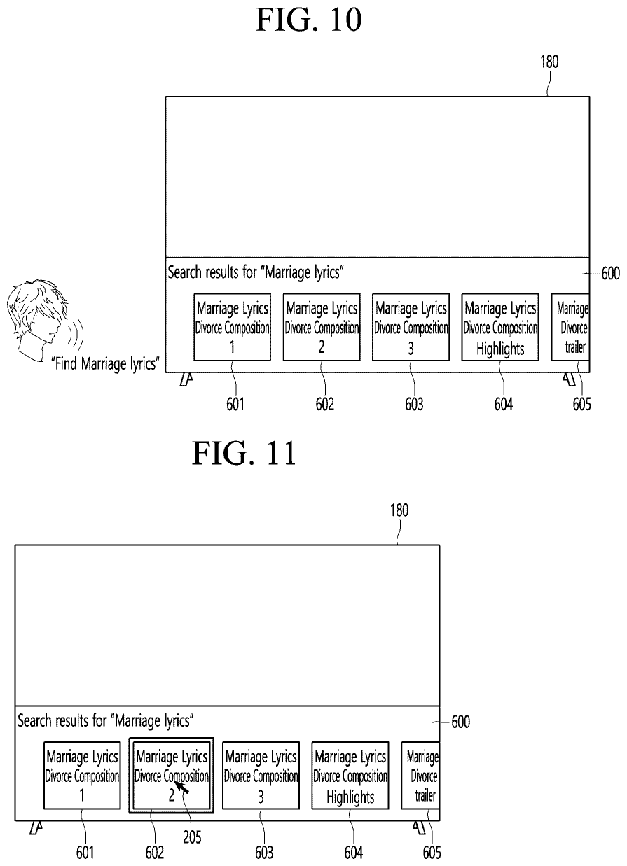

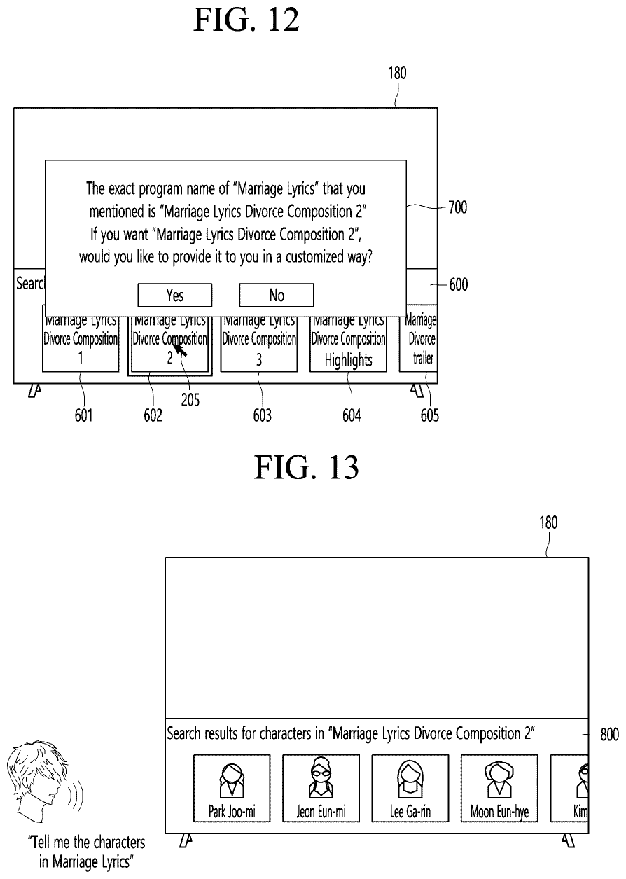

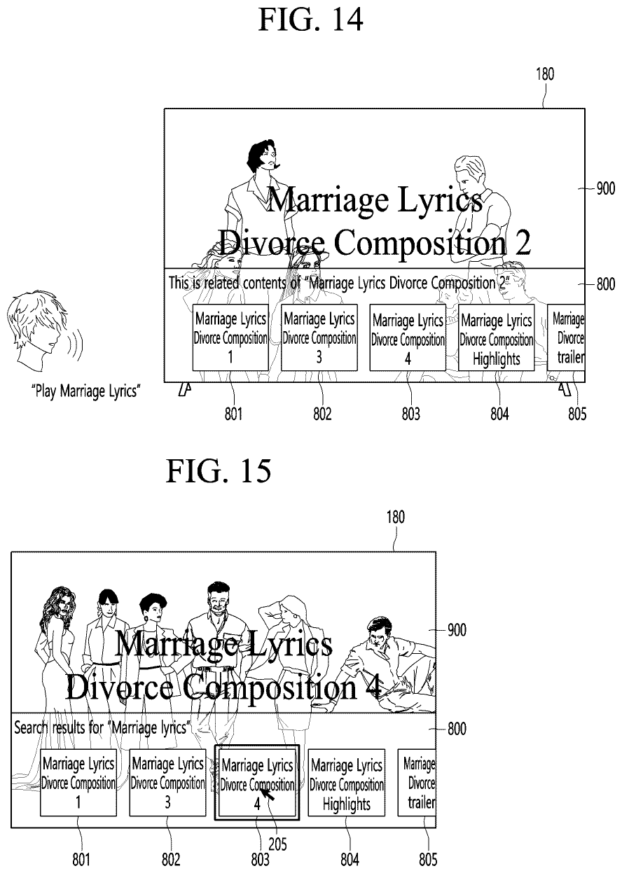

FIG. 10 is an example diagram illustrating a display device according to an embodiment of the present disclosure performing an operation corresponding to a voice command according to the uttered content name, FIG. 11 is an exemplary drawing illustrating a display device according to an embodiment of the present disclosure receiving a command to select one content from a voice command result, FIG. 12 is an exemplary drawing showing a display device according to an embodiment of the present disclosure outputting a message for confirming whether to store an uttered content name in a content name DB, FIG. 13 is an exemplary drawing illustrating a display device according to an embodiment of the present disclosure performing an operation corresponding to a voice command by replacing an uttered content name with an official content name and FIG. 14 is an exemplary drawing illustrating a display device according to an embodiment of the present disclosure displaying another season when the content corresponds to a series and the voice command is a content playback command.

When the controller 170 receives “Find Marriage lyrics” as a voice command, the controller 170 can determine whether the uttered content name “Marriage lyrics” is stored in the content name DB. If “Marriage lyrics” is not stored in the content name DB, the controller 170 can perform an operation corresponding to the voice command “Find Marriage lyrics” and display the content search result 600 as a voice command result as illustrated in FIG. 10. The content search result 600 can include a plurality of contents 601 to 605. The plurality of contents 601 to 605 can be contents related to the uttered content name.

The controller 170 can receive a command to select one among the plurality of contents 601 to 605. As in the example of FIG. 11, the controller 170 can receive a command to select a second content 602 through the pointer 205.

When the controller 170 receives a command to select one content, it can display a message to check whether to manage the official content name of the selected content and the uttered content name by mapping them. For example, the controller 170 can output a message 700 such as, “The exact program name of “Marriage Lyrics” that you mentioned is “Marriage Lyrics Divorce Composition 2” If you want “Marriage Lyrics Divorce Composition 2”, would you like to provide it to you in a customized way?”.

When the controller 170 receives a command to map the official content name of the selected content and the uttered content name, it can map the official content name “Marriage Lyrics Divorce Composition 2” of the selected content and the uttered content name “Marriage Lyrics” and store them in the content name DB. That is, if the selected content corresponds to a series, the controller 170 can map the official content name including the season number of the selected content (‘Marriage Lyrics Divorce Composition 2’ in the example of FIG. 11) to the uttered content name ‘Marriage Lyrics’ and store them in the content name DB.

As in the example of FIG. 13, if the controller 170 receives a voice command such as “Tell me the characters in Marriage Lyrics,” it can obtain the official content name mapped to the uttered content name ‘Marriage Lyrics’ in the content name DB, and the official content name can include the season number. The controller 170 can obtain the official content name ‘Marriage Lyrics Divorce Composition 2’ mapped to the uttered content name ‘Marriage Lyrics’. In this case, the controller 170 can perform an operation corresponding to the voice command “Tell me the characters in Marriage Lyrics Divorce Composition 2” according to the official content name. That is, the controller 170 can perform an operation corresponding to the voice command “Tell me the characters in Marriage Lyrics Divorce Composition 2” by replacing the uttered content name with the official content name, and display the character search result 800 as the voice command result.

Meanwhile, as in the example of FIG. 14, the controller 170 can also receive “Play Marriage Lyrics” as the voice command. The controller 170 can obtain “Marriage Lyrics Divorce Composition 2” as the official content name, and if the voice command is a content playback command, play the content corresponding to the official content name according to the voice command. In addition, the controller 170 can search for contents related to the content corresponding to the official content name, for example, another season.

The controller 170 can display the content corresponding to the official content on the content playback screen 900 and further display related contents information 800. The related contents information may include other season contents 801 to 803. That is, if the content corresponding to the official content name is a series and the voice command is the content playback command, the controller 170 may play the content corresponding to the official content name while displaying other seasons information.

Again, FIG. 5 is described.

The controller 170 can determine whether content of another season is selected (S123).

The controller 170 can obtain whether content of another season is selected through the displayed other seasons information.

When another season is selected, the controller 170 can map the uttered content name and the content of the selected another season and store them in the content name DB (S125).

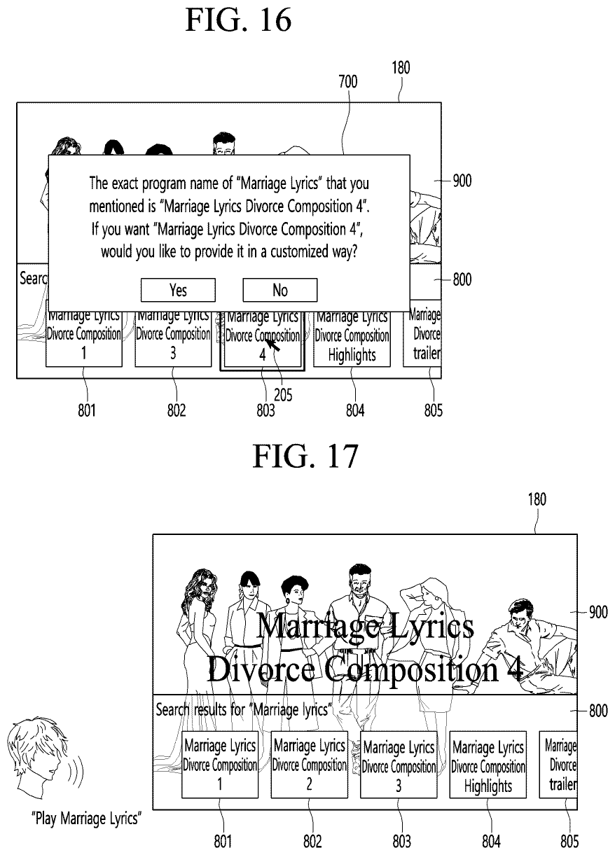

FIG. 15 is an exemplary drawing illustrating a display device according to an embodiment of the present disclosure receiving a command to select content of another season, FIG. 16 is an exemplary drawing showing a message output appearance for confirming whether to change an official content name mapped to an uttered content name by a display device according to an embodiment of the present disclosure and FIG. 17 is an exemplary drawing showing an operation appearance of a display device according to an embodiment of the present disclosure according to a change in an official content name.

As described in FIG. 14, the controller 170 can display a content on the content playback screen 900 and further display related contents information 800, and at this time, receive a command to select content of another season from the related contents information 800 through the pointer 205.

As illustrated in FIG. 15, the controller 170 can receive a command to select content of another season, for example, a third other season content 803, through the pointer 205. The controller 170 can display a content corresponding to the selected third other season content 803 on the content playback screen 900.

In addition, as illustrated in FIG. 16, when content of another season is selected, the controller 170 can display a message 700 for confirming whether to change the official content name mapped to the uttered content name included in the voice command to a content of another season. For example, the message 700 may be something like, “The exact program name of “Marriage Lyrics” that you mentioned is “Marriage Lyrics Divorce Composition 4”. If you want “Marriage Lyrics Divorce Composition 4”, would you like to provide it in a customized way?” However, this is only an example, and it is reasonable that it is not limited to this.

When the controller 170 receives a command to change the official content name mapped to the uttered content name included in the voice command to a content of a different season, it can change the official content name ‘Marriage Lyrics Divorce Composition 2’ mapped to the uttered content name ‘Marriage Lyrics’ to ‘Marriage Lyrics Divorce Composition 4’ and store them in the content name DB.

Therefore, when the controller 170 receives a voice command such as “Play the Marriage Lyrics,” it can obtain the official content name ‘Marriage Lyrics Divorce Composition 4’ mapped to the uttered content name ‘Marriage Lyrics’ and perform an operation corresponding to the voice command, which may be the same as the example of FIG. 17.

That is, when the content corresponding to the official content name is a series, the controller 170 can output the operation result according to the voice command and the contents of another season together. In addition, when the content of another season is selected, the controller 170 can change the season number of the official content name mapped to the uttered content name to the number of another selected season.

According to one embodiment of the present disclosure, the display device 100 can operate in the above-described manner when receiving a voice command by constructing a content name DB, etc. inside it.

According to another embodiment of the present disclosure, the display device 100 can operate in the above-described manner through communication with an external server upon receiving a voice command.

FIG. 18 is a block diagram illustrating a display device according to an embodiment of the present disclosure communicating with an external server.

The display device 100 can communicate with an external server. In the example of FIG. 18, the external server may be an AI server 10, but this is only an example and is not limited thereto.

When the controller 170 receives a voice command, it can transmit the received voice command to the AI server 10. When the AI server 10 receives the voice command, it can perform an intent analysis of the voice command. Based on the intent analysis result, the AI server 10 can request a search to a search server 20 if a search operation is required.

The AI server 10 can obtain whether the uttered content name included in the voice command is stored in the content name DB. The AI server 10 can obtain an official content name corresponding to the uttered content name from the content name DB. The AI server 10 can store new data in the content name DB or modify it.

The AI server 10 can request the content DB and receive necessary data from the content DB if content data, content-related information, etc. are needed based on at least one of the intent analysis results and the search results.

Through this, the controller 170 can obtain the official content name and the operation result of the voice command changed to the official content name through the external server that manages the content name DB.

Meanwhile, the display device 100 has recognized the content corresponding to the uttered content name based on the content name DB set for each individual user. According to another embodiment of the present disclosure, the display device 100 can recognize the content not only based on the content name DB, but also based on a name-based utterance log DB used by multiple users.

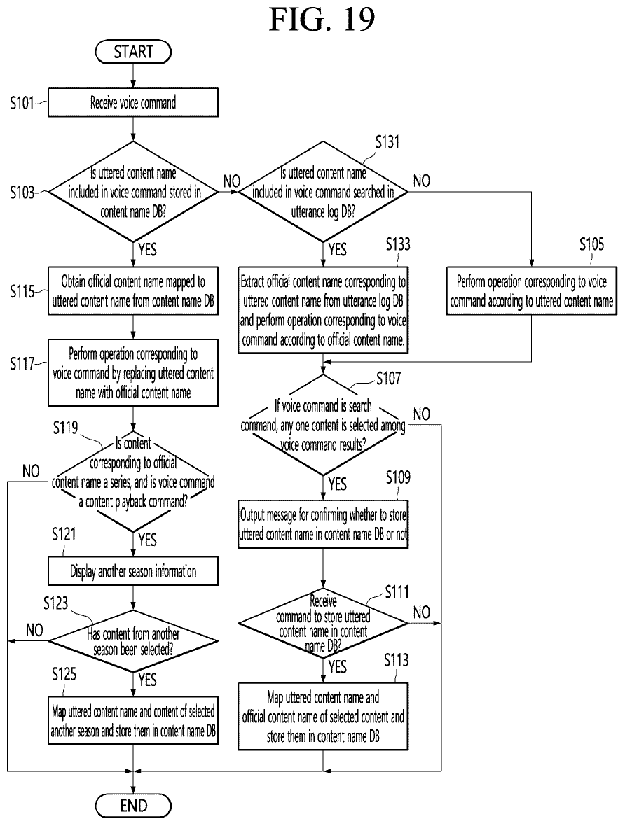

FIG. 19 is a flowchart illustrating an operation method of a display device according to another embodiment of the present disclosure.

The controller 170 may receive a voice command (S101) and obtain whether the uttered content name included in the received voice command is stored in the content name DB (S103).

If the uttered content name is not stored in the content name DB, the controller 170 may obtain whether the uttered content name included in the voice command is searched in the utterance log DB (S131).

The utterance log database (the utterance log DB) may be a database constructed based on uttered content names included in voice commands of multiple users and contents selected according to the voice commands. The utterance log DB may be set based on the frequency of multiple users.

That is, the utterance log DB can include data that extracts uttered content names that many users use instead of official content names based on voice commands of many users and contents selected accordingly, and maps them to official content names.

If the uttered content name is not in the content name DB, the controller 170 can determine whether the uttered content name exists in the utterance log DB.

If the uttered content name is searched in the content name DB, the controller 170 can extract an official content name corresponding to the uttered content name from the utterance log DB and perform an operation corresponding to the voice command according to the official content name (S133).

That is, if the uttered content name is searched in the content name DB, the controller 170 can extract an official content name corresponding to the uttered content name from the utterance log DB and perform an operation corresponding to the voice command that changes the uttered content name to the official content name.

If the uttered content name is not searched in the content name DB, the controller 170 can perform an operation corresponding to the voice command according to the uttered content name (S105).

Except for steps S131 and S133, the remaining steps are the same as those described with reference to FIG. 5, and thus, redundant descriptions will be omitted.

That is, according to another embodiment of the present disclosure, if the controller 170 fails to obtain the official content name from the content name DB, it can obtain the official content name from the utterance log DB.

In this way, if the official content name corresponding to the uttered content name cannot be found because there is no data set to be customized by the user, there is an advantage in that the result of a voice command with higher accuracy can be provided for the voice command according to the uttered content name by finding the official content name based on the utterance log DB constructed through the utterance records of multiple users.

According to an embodiment of the present disclosure, the above-described method may be implemented with codes readable by a processor on a medium in which a program is recorded. Examples of the medium readable by the processor include a ROM (Read Only Memory), a Random Access Memory (RAM), a CD-ROM, a magnetic tape, a floppy disk, an optical data storage device, and the like.

The display device as described above is not limited to the configuration and method of the above-described embodiments, but the embodiments may be configured by selectively combining all or part of each embodiment such that various modifications can be made.

1-15. (canceled)

16. A display device comprising:
a display; and
a controller configured to:
receive a voice command including an uttered content name:
obtain an official content name mapped to the uttered content name; and
output via the display an operation result corresponding to the voice command based on the uttered content name being changed to the official content name.

17. The display device of claim 16, wherein the controller is further configured to determine whether the uttered content name is stored in a content name database to obtain the official content name.

18. The display device of claim 17, wherein the controller is further configured to obtain the official content name from the content name database based on the uttered content name being stored in the content name database.

19. The display device of claim 17, wherein the controller is further configured to output the operation result corresponding to the voice command based on the uttered content name based on the uttered content name not being stored in the content name database.

20. The display device of claim 19, wherein based on a search result of the uttered content name being output as a result of the operation result, the controller is further configured to output a message requesting confirmation whether to set the uttered content name as a user-customized content name for the official content name of a selected content among the search result.

21. The display device of claim 20, wherein based on receiving a command to set the uttered content name as the user-customized content name, the controller is further configured to store the uttered content name in the content name database to be mapped with the official content name of the selected content.

22. The display device of claim 19, wherein based on a search result of the uttered content name being output as a result of the operation result, the controller is further configured to store the uttered content name in the content name database to be mapped with the official content name of a selected content among the search result.

23. The display device of claim 22, wherein the controller is further configured to store the uttered content name in the content name database to be mapped with the official content name including a season number based on the selected content corresponding to a series.

24. The display device of claim 16, wherein based on the official content name corresponding to a series, the controller is further configured to output the operation result corresponding to the voice command along with content from other seasons of the series.

25. The display device of claim 24, wherein based on a selection of a particular content from the other seasons, the controller is configured store the uttered content name in a content name database to be mapped with a season number of the particular content of the other season.

26. The display device of claim 16, further comprising a memory configured to store a content name database in which one or more user-customized uttered content names are mapped to each of at least one or more official content name.

27. The display device of claim 16, wherein the controller is configured to obtain the official content name and the operation result from an external server that manages a content name database storing the official content name.

28. The display device of claim 16, wherein the controller is further configured to obtain the official content name from a content name database customized to a user or an utterance log database set based on a frequency of multiple users.

29. The display device of claim 28, wherein the controller is further configured to obtain the official content name from the utterance log database based on the official content name not being obtained from the content name database.

30. An operation method of a display device, comprising:
receiving a voice command including an uttered content name;
obtaining an official content name mapped to the uttered content name; and
outputting an operation result corresponding to the voice command based on the uttered content name being changed to the official content name.
